(19) United States
(12) Patent Application Publication
(10) Pub. No.: US 2010/0171050 A1
(43) Pub. Date: Jul. 8, 2010

(54) METHOD FOR REGENERATING A SURFACE OF AN OPTICAL ELEMENT IN AN XUV RADIATION SOURCE, AND XUV RADIATION SOURCE

(75) Inventors: Frederik Bijkerk, Amsterdam (NL); Andrey Evgenjevich Yakshin, Nieuwegein (NL); Mohamed Reda Akdim, Nieuwegein (NL); Aart Willem Kleijn, Amsterdam (NL)

Correspondence Address: PAUL, HASTINGS, JANOFSKY & WALKER LLP, 875 15th Street, NW, Washington, DC, 20005, US

(73) Assignee: STICHTING VOOR FUNDAMENTEEL ONDERZOEK DER MATERIE

(21) Appl. No.: 12/444,994

(22) PCT Filed: Oct. 11, 2007
(86) PCT No.: PCT/NL07/00258

§ 371 Date: Mar. 15, 2010

(30) Foreign Application Priority Data
Oct. 13, 2006 (NL) 1032674

(51) Int. Cl. H05H 1/24; G21K 5/02

(52) U.S. Cl. 250/504 R

(57) ABSTRACT

Method for regenerating a surface of an optical element in a radiation source for electromagnetic radiation with a wavelength in the extreme ultraviolet wavelength range, H (EUV, XUV) in particular with a wavelength in the wavelength range between 10 nm and 15 nm, this radiation source comprising at least a chamber for arranging therein a plasma generating XUV or EUV radiation and the optical element, in particular a collector for bundling XUV or EUV radiation generated by the plasma and causing it to exit the chamber, according to which method a first Si, C or metal compound is arranged in the chamber which reacts in an equilibrium reaction with the material of the surface of the collector to form respectively a second Si, C or metal compound bonded to this surface, and XUV or EUV radiation source adapted for such a method.

The invention relates to a method for regenerating a surface of an optical element in a radiation source for electromagnetic radiation with a wavelength in the extreme ultraviolet (XUV) wavelength range, in particular with a wavelength in the wavelength range between 10 nm and 15 nm, this radiation source comprising at least a chamber for arranging therein a plasma generating XUV radiation and the optical element, in particular a collector for bundling XUV radiation generated by the plasma and causing it to exit the chamber.

A radiation source for electromagnetic radiation is known with a wavelength in the deep ultraviolet (DUV) wavelength range, in particular with a wavelength of 193 nm, which is applied in the production of semiconductor circuits within the technical field of nanolithography.

The aim of further miniaturization of semiconductor circuits has given rise to the development of an XUV radiation source.

The currently known XUV radiation source substantially comprises a vacuum chamber or ultra-high vacuum chamber, which is provided with per se known means suitable for the purpose of bringing to a plasma state a material introduced into the chamber which is known to generate an XUV radiation with a determined wavelength when in this plasma state. The generated XUV radiation is bundled and guided out of the chamber using a collector, for instance a multilayer mirror or an assembly of curved mirrors of for instance ruthenium (Ru) or palladium (Pd).

In the currently known XUV radiation source the phenomenon occurs that a (secondary) plasma is formed close to the surface of the collector by the XUV radiation generated by the (primary) plasma, the ions of which (secondary) plasma exert a sputtering action on the surface of the collector, which consequently erodes. In order to limit the erosion of the collector as much as possible, the intensity of the known XUV radiation source can be kept as low as possible although, in view of the intended applications of this radiation source, it is precisely a relatively high intensity that is required.

It is an object of the invention to provide an XUV radiation source with which high-intensity XUV radiation can be generated without erosion of the collector occurring therein.

This object is achieved with a method of the type stated in the preamble, which is characterized according to the invention by the successive steps of

(i) providing the radiation source, and

(ii) arranging in the chamber a first compound which reacts in an equilibrium reaction with the material of the surface of the optical element to form a second compound bonded to this surface.

A method according to the invention provides the option of establishing a dynamic balance on the surface of the collector, wherein material which is extracted from the surface by the sputtering action of the ions in the secondary plasma is supplemented by the second compound formed from the first compound.

With a method according to the invention the first compound is for instance ionized by the generated XUV radiation, and the ionized compound then reacts with the surface of the collector, wherein the thus formed second compound grows on this surface and forms a compensation for material extracted from this surface as a result of the sputtering action of the secondary plasma.

In an embodiment of a method according to the invention, wherein the optical element is a mirror with a multilayer structure and comprises at least a silicon (Si)-containing top layer, the first compound is a first Si compound which, through the action of the generated XUV radiation, reacts with the Si in the top layer in an equilibrium reaction to form a second Si compound bonded to this top layer.

In order to enable accurate setting of the above stated dynamic balance, hydrogen gas (H₂) is preferably also arranged in the chamber of such an XUV radiation source.

Hydrogen gas provides the advantage that it dissociates through the action of XUV radiation in accordance with the reaction equation:

e+H₂→2H+e

wherein reactive hydrogen radicals are formed which can attach directly to the surface of the collector or which, through a reaction with the first compound, form a reactive radical which can bond to the surface of the collector.

It is also possible for the hydrogen gas to be dissociatively ionized, thus helping to maintain the discharge in the secondary plasma in accordance with the reaction equation:

e+H₂→H₂⁺e

The first Si compound is for instance a silane (SiₙH₂ₙ₊₂), in which n is a whole number smaller than or equal to 6.

Silanes display dissociation in a plasma, wherein reactive radicals are formed which can bond to the surface of the collector. These dissociations progress for instance in accordance with one of the following reaction equations:

e+SiH₄→SiH₂+2H+e(83%)

→SiH₃+H+e(17%)

e+Si₂H₆→SiH₃+SiH₂+H+e

Silanes, for instance SiH₄, further display dissociative attachment in a plasma while forming negative ions in accordance with the reaction equation:

e+SiH₄→SiH₃⁻+H

Silanes further contribute toward sustaining of a secondary plasma by means of dissociative ionization, for instance in accordance with one of the following reaction equations:

e+SiH₄→SiH₂⁺+2H+2e

e+Si₂H₆→Si₂H₄⁺+2H+2e

Silanes in a radiation source according to the invention are also subject to recombinations which result in loss of negative ions, for instance as according to one of the following reaction equations:

SiH₂⁺+SiH₃⁻→SiH₂+SiH₃

Si₂H₄⁺SiH₃⁻→SiH₃+2SiH₂

H₂⁺SiH₃⁻→H₂SiH₃

Neutral-neutral recombinations further occur, for instance in accordance with one of the following reaction equations:

SiₙH₂ₙ₊₂+H→SiₙH₂ₙ₊₁+H₂

SiₙH₂ₙ₊₂+SiH₂→Siₙ₊₁H₂ₙ₊₄

H+Si₂H₆→SiH₃+SiH₄

H₂+SiH₂→SiH₄

SiH₃+SiH₃→SiH₄+SiH₂

Si₂H₅+Si₂H₅→Si₄H₁₀

In an alternative embodiment the first Si compound is an alkyl triethoxysilane, the alkyl group is optionally a substituted alkyl group.

The first Si compound in this latter embodiment is for instance (1H,1H,2H,2H-perfluorodecyl)-triethoxysilane (CF₃—(CF₂)₇—(CH₂)₂—Si(OC₂H₅)₃).

It has been found that a (substituted) alkyl triethoxysilane is particularly suitable for preventing the absorption of water molecules on the Si top layer of a mirror with a multilayer structure, in accordance with a reaction mechanism in which the first Si compound reacts with water, wherein the ethoxy groups are substituted by hydroxyl groups with separation of ethanol, which hydroxyl groups then react with hydroxyl groups bonded to the Si top layer with separation of water. The thus formed second Si compound bonded to the Si top layer forms a self-assembled monolayer film (SAM-film) on the top layer of the multilayer mirror, which thus replaces the Si of the top layer which has disappeared due to sputtering.

In an embodiment of a method according to the invention, wherein the optical element is a mirror with a multilayer structure and comprises at least a silicon (Si)-containing top layer, the multilayer structure comprises for instance a stack of molybdenum (Mo) films separated by thin layers of silicon (Si).

In an embodiment of a method according to the invention, wherein the optical element is a mirror with a multilayer structure and comprises at least a carbon (C)-containing top layer, the first compound is a first C compound which reacts in an equilibrium reaction with the C in the top layer to form a second C compound bonded to this top layer.

The first C compound is for instance a hydrocarbon (CH) compound.

In an embodiment of a method according to the invention, wherein the optical element comprises an assembly of curved mirrors of a metal (Mt), the first compound is a first Mt compound which reacts in an equilibrium reaction with the metal of the mirrors to form a second Mt compound bonded to the surface of the mirrors.

The metal (Mt) is for instance selected from the group comprising ruthenium (Ru), rhodium (Rh) and palladium (Pd).

The invention further relates to a radiation source for electromagnetic radiation with a wavelength in the extreme ultraviolet (XUV) wavelength range, in particular with a wavelength in the wavelength range between 10 nm and 15 nm, comprising at least a chamber for arranging therein an XUV radiation-generating plasma and an optical element, in particular a collector for bundling XUV radiation generated by the plasma and causing it to exit the chamber, wherein a first compound is arranged in the chamber for the purpose of regenerating a surface of the optical element according to the above described method, which first compound reacts in an equilibrium reaction with the material of the surface of the optical element to form a second compound bonded to this surface.

In an embodiment of an XUV radiation source according to the invention, wherein the optical element is a mirror with a multilayer structure and comprises at least a silicon (Si)-containing top layer, the first compound is a first Si compound which, through the action of the generated XUV radiation, reacts with the Si in the top layer in an equilibrium reaction to form a second Si component bonded to this top layer.

In order to enable accurate setting of the above stated dynamic balance, hydrogen gas (H₂) is preferably arranged in the chamber of such an XUV radiation source.

The first Si compound is for instance a silane (SiₙH₂ₙ₊₂), in which n is a whole number smaller than or equal to 6.

In an alternative embodiment the first Si compound is an alkyl triethoxysilane, the alkyl group of which is optionally a substituted alkyl group.

The first Si compound in this latter embodiment is for instance (1H,1H,2H,2H-perfluorodecyl)-triethoxysilane (CF₃—(CF₂)₇—(CH₂)₂—Si(OC₂H₅)₃).

In an XUV radiation source according to the invention, wherein the optical element is a mirror with a multilayer structure and comprises at least a silicon (Si)-containing top layer, the multilayer structure comprises for instance a stack of molybdenum (Mo) films separated by thin layers of silicon (Si).

In an embodiment of an XUV radiation source according to the invention, wherein the optical element is a mirror with a multilayer structure and comprises at least a carbon (C)-containing top layer, the first compound is a first C compound which reacts in an equilibrium reaction with the C in the top layer to form a second C compound bonded to this top layer.

The first C compound is for instance a hydrocarbon (CH) compound.

In an embodiment of an XUV radiation source according to the invention, wherein the optical element comprises an assembly of curved mirrors of a metal (Mt), the first compound is a first Mt compound which reacts in an equilibrium reaction with the metal of the mirrors to form a second Mt compound bonded to the surface of the mirrors.

The metal (Mt) is for instance selected from the group comprising ruthenium (Ru), rhodium (Rh) and palladium (Pd).

The invention will be elucidated hereinbelow on the basis of an exemplary embodiment, with reference to the drawing.

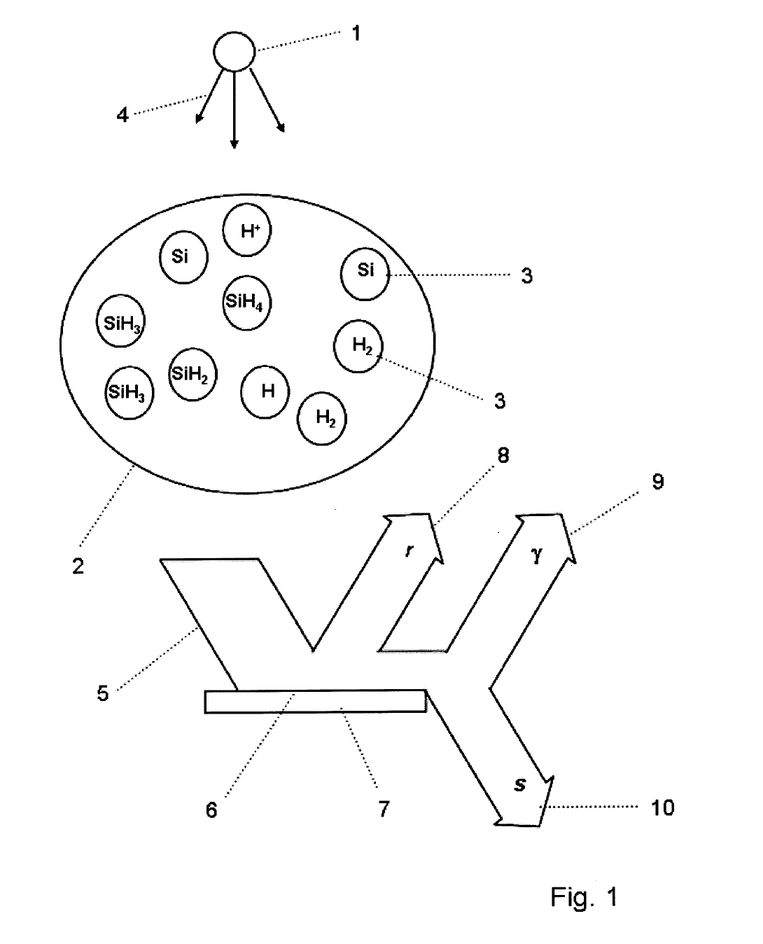

In the drawing, FIG. 1 shows a schematic representation of an XUV radiation source with a collector according to the invention.

FIG. 1 shows a radiation source 1 with a primary plasma (not shown) for generating XUV radiation (represented by the three arrows 4), a collector 7 formed by a multilayer structure with a top layer 6 of Si, and a secondary plasma 2, which is composed of ions and radicals of silanes and hydrogen (coming from a first Si compound and represented by particles 3). Secondary plasma 2 produces a continuous flux 5 of particles which are incident upon surface 6 of collector 7. A fraction r of the incident flux 5, represented by arrow 8, is reflected on surface 6, a fraction β of the incident flux 5 reacts on surface 6, wherein a part γ, represented by arrow 9, undergoes a recombination reaction and a part s, represented by arrow 10, attaches to surface 6 of collector 7 while forming a second Si compound, this in accordance with the equations

r=1−g

and

β=γ+s

It is noted that FIG. 1 is a schematic representation which is limited to embodiments in which the collector has a Si-containing top layer and the first compound is a Si compound. In embodiments in which the collector has a top layer of C or a metal, the secondary plasma is composed respectively of ions and radicals of C compounds or of metal compounds of the metal corresponding with the metal of the top layer.

1. Method for regenerating a surface of an optical element (7) in a radiation source for electromagnetic radiation (4) with a wavelength in the extreme ultraviolet (XUV) wavelength range, in particular with a wavelength in the wavelength range between 10 nm and 15 nm, this radiation source comprising at least a chamber for arranging therein a plasma (1) generating XUV radiation and the optical element (7), in particular a collector (7) for bundling XUV radiation generated by the plasma (1) and causing it to exit the chamber, comprising the successive steps of
(i) providing the radiation source, and
(ii) arranging in the chamber a first compound (2) which is reactive with the material of the surface (6) of the optical element (7), characterized by the successive step of
(iii) establishing, in an equilibrium reaction of the first compound (2) with the material of the surface (6), a dynamic balance on the surface (6), wherein material which is extracted from the surface (6) by a sputtering action of ions in a secondary plasma is supplemented by a second compound formed from the first compound.

2. Method as claimed in claim 1, wherein the optical element (7) is a mirror with a multilayer structure and comprises at least a silicon (Si)-containing top layer (6), characterized in that the first compound (2) is a first Si compound which is reactive in an equilibrium reaction with the Si in the top layer (6) to form a second Si compound bonded to this top layer (6).

3. Method as claimed in claim 2, characterized by the step of
in the step (ii) also arranging hydrogen gas (H₂) in the chamber.

4. Method as claimed in claim 2, characterized in that the first Si compound is a silane (SiₙH₂ₙ₊₂), wherein n≦6.

5. Method as claimed in claim 2, characterized in that the first Si compound is an alkyl triethoxysilane.

6. Method as claimed in claim 2, characterized in that the first Si compound is an alkyl triethoxysilane wherein the alkyl group is a substituted alkyl group.

7. Method as claimed in claim 6, characterized in that the first Si compound is (1H,1H,2H,2H-perfluorodecyl)-triethoxysilane (CF₃—(CF₂)₇—(CH₂)₂—Si(OC₂H₅)₃).

8. Method as claimed in claim 2, characterized in that the multilayer structure comprises a stack of molybdenum (Mo) films separated by thin layers of silicon (Si).

9. Method as claimed in claim 1, wherein the optical element is a mirror with a multilayer structure and comprises at least a carbon (C)-containing top layer, characterized in that the first compound is a first C compound which is reactive in an equilibrium reaction with the C in the top layer to form a second C compound bonded to this top layer.

10. Method as claimed in claim 9, characterized in that the first C compound is a hydrocarbon (CH) compound.

11. Method as claimed in claim 1, wherein the optical element comprises an assembly of curved mirrors of a metal (Mt), characterized in that the first compound is a first Mt compound which is reactive in an equilibrium reaction with the metal of the mirrors to form a second Mt compound bonded to the surface of the mirrors.

12. Method as claimed in claim 11, characterized in that the metal (Mt) is selected from the group comprising ruthenium (Ru), rhodium (Rh) and palladium (Pd).
